(19) United States
(12) Patent Application Publication
(10) Pub. No.: US 2006/0112855 A1
(43) Pub. Date: Jun. 1, 2006

(54) Pigment composition

(75) Inventors: Kjell Rune Andersson, Goteborg (SE); Joakim Carlen, Goteborg (SE); Erik Lindgren, Bohus (SE)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL N.V., Arnhem (NL)

(21) Appl. No.: 11/267,757

(22) Filed: Nov. 3, 2005

Related U.S. Application Data
(60) Provisional application No. 60/629,810, filed on Nov. 9, 2004.

(30) Foreign Application Priority Data
Nov. 8, 2004 (EP) 04105595.5

(51) Int. Cl. B41M 5/00; C04B 14/00

(52) U.S. Cl. 106/400; 428/32.25

(57) ABSTRACT

The invention relates to a pigment composition in the form of an aqueous dispersion or slurry comprising: (c) porous aggregates formed by aggregation of colloidal primary particles of silica, aluminosilicate or a mixture thereof in an aqueous sol, said porous aggregates having a mean diameter from about 0.03 to about 25 μm, and, (d) extender particles where the mean size of at least one dimension is larger than the mean diameter of the porous aggregates, wherein the weight ratio of porous aggregates to extender particles is from about 0.01:1 to about 3:1. The invention further relates to a process for its production, a composition for coating paper or paper board and a process for its production, and a process for coating paper or paper board and paper or paper board obtainable by the process.

This application claims priority based on European Patent Application No. 04105595.5, filed on Nov. 8, 2004 and on U.S. Provisional Patent Application No. 60/629,810, filed Nov. 9, 2004.

The present invention relates to a pigment composition and a process for its production, a composition for coating paper or paper board and a process for its production, and a process for coating paper or paper board and paper or paper board obtainable by the process.

### BACKGROUND OF THE INVENTION

The development of ink-jet printers has led to a demand for paper that is suitable for that purpose. Particularly, there is a demand for paper that is simple to produce but still enables ink-jet printing of high quality.

It has been disclosed to use various kinds of coatings to produce paper suitable for ink-jet printing.

US Patent Application Publication 2002/0039639 discloses incorporating a water soluble metal salt in an ink receiving layer comprising pigments and a conventional binder.

U.S. Pat. No. 4,554,181 discloses a recording surface including a combination of a water soluble polyvalent metal and a cationic polymer.

US Patent Application Publication 2004/0255820 discloses a pigment that is surface treated with a water-soluble polyvalent metal salt.

US Patent Application Publication 2005/0106317 discloses a method for preparing an ink-jet recording material comprising the steps of forming at least one porous layer containing silica particles with an average secondary particle size of 500 nm or less, and coating a coating solution for preparing an inorganic particles-containing layer so that a solid content of the coated inorganic particles became 0.33 g/m² or less on the porous layer.

U.S. Pat. No. 6,797,347 discloses an ink-jet paper comprising a base paper and a coating thereon, wherein said coating contains an inorganic pigment modified with a positively charged complex and a binder. The positively charged complex contains a polyvalent metal ion and an organic ligand.

US Patent Application Publication 2003/0099816 discloses an ink jet-recording material comprising a substrate and a transparent ink-receiving layer comprising a binder and a plurality of particles formed by dispersing amorphous silica particles and applying a strong mechanical stress to divide the particles.

Other examples of disclosures relating to coated paper are WO 03/011981, WO 01/53107, WO 01/45956, EP 947349, EP 1120281 and U.S. Pat. No. 5,551,975.

It is an object of the invention to provide a pigment composition suitable for coating paper or paper board for ink-jet printing and that is simple to produce.

It is another object of the invention to provide a coating formulation that is simple to apply on the surface of paper or paper board to make it suitable for ink-jet printing.

It is still another object of the invention to provide a paper or paper board suitable for ink-jet printing that is simple to produce.

### SUMMARY OF THE INVENTION

Thus, one aspect of the invention relates to a pigment composition in the form of an aqueous dispersion comprising:
a) porous aggregates formed by aggregation of colloidal primary particles of silica, aluminosilicate or a mixture thereof in an aqueous sol, said porous aggregates having a mean diameter from about 0.03 μm to about 25 μm, and,
b) extender particles where the mean size of at least one dimension is larger than the mean diameter of the porous aggregates,
   wherein the weight ratio of porous aggregates to extender particles is from about 0.01:1 to about 3:1, preferably from about 0.01:1 to about 2:1, most preferably from about 0.05:1 to about 1.5:1.

### DETAILED DESCRIPTION OF THE INVENTION

The mean particle diameter of the colloidal primary particles is preferably from about 2 nm to about 75 nm, most preferably from about 3 nm to about 50 nm. The surface area of the primary particles is preferably from about 35 m²/g to about 1400 m²/g, most preferably from about 50 m²/g to about 1000 m²/g. In an embodiment the surface area is up to about 600 m²/g, preferably up to about 450 m²/g, most preferably up to about 300 m²/g. The dry content of the aqueous sol of primary particles is preferably from about 0.5 wt % to about 60 wt %, most preferably from about 1 wt % to about 50 wt %.

The term diameter as used herein refers to the equivalent spherical diameter.

The colloidal primary particles of silica or aluminosilicate have preferably been formed from an aqueous solution of alkali metal silicate where alkali metal ions are removed through an ion exchange process or where the pH of the alkali metal silicate solution has been reduced by the addition of an acid. A process based on ion exchange follows the basic principles described in R. K. Iler, “The Chemistry of Silica” 1979, pages 333-334 and results in an aqueous sol comprising colloidal negatively or positively charged particles of silica or aluminosilicate. A process based on pH-reduction of alkali metal silicate follows the basic principles described in e.g. U.S. Pat. Nos. 5,176,891, 5,648,055, 5,853,616, 5,482,693, 6,060,523 and 6,274,112.

Particularly preferred sols comprise colloidal primary particles of silica that may or may not be surface modified, for example with a metal oxide such as oxide of aluminium, titanium, chromium, zirconium, boron or any other suitable metal.

Suitable aqueous sols of colloidal primary particles of silica or aluminosilicate are commercially available, for example under the trademarks Ludox™, Snowtex™, Bindzil™, Nyacol™, Vinnsil™ or Fennosil™.

It has been found that if silica or aluminosilicate is allowed to dry to form a powder, a sol formed by dispersing such powder has different properties than a sol where the colloidal particles never have been dried to a powder, as is the case when the sol has been prepared from alkali metal silicate by ion exchange or pH-reduction.

The aggregation of the primary particles in the sol to form a dispersion of porous aggregates may be performed with any suitable method, such as those described in R. K. Iler, “The Chemistry of Silica” 1979, pages 364-407. The degree of aggregation can be followed by measuring the viscosity and applying the Einstein and Mooney equations (see e.g. R. K. Iler, “The Chemistry of Silica” 1979, pages 360-364). The aggregation may be performed as a separate step or in a mixture also comprising extender particles.

In one embodiment, an anionic sol (comprising negatively charged colloidal primary particles) and a cationic sol (comprising positively charged colioidal primary particles) are mixed, resulting in the formation of porous aggregates of primary particles from both the sols.

In another embodiment a salt, preferably selected from divalent, multivalent or complex salts, is added to an anionic or cationic sol also resulting in the formation of porous aggregates. Examples of salts are aluminium chloride, poly aluminium chloride, poly aluminium silicate sulfate, aluminium sulfate, zirconium carbonates, zirconium acetates, alkali metal borates, and mixtures thereof.

In still another embodiment a bridging substance is used to form the aggregates from the primary particles. Examples of suitable bridging substances are syntetic and natural polyelectrolytes such as CMC (carboxymethyl cellulose), PAM (polyacrylamides), polyDADMAC (poly diallyl dimethyl ammoniumchloride), polyallyl amines, polyamines, starch, guar gums, and mixtures thereof.

Any combination including one, two or all three of the above aggregation methods can also be employed.

Each porous aggregate is formed from at least three primary particles, which inherently gives at least some pores. The mean particle diameter of the aggregates is preferably from about 0.05 to about 10 μm, most preferably from about 0.1 μm to about 1.5 μm. It is to be understood that the average diameter of the porous aggregates is always larger than the average diameter of the primary particles they are formed from.

The extender particles could be of various geometrical shapes, for example substantially flake shaped, rodlike or spherical, wherein the mean size of at least one dimension is larger, preferably from about 1.3 to about 500 times larger, most preferably from about 1.3 to about 200 times larger than the mean diameter or the porous aggregates. The extender particles are preferably of an inorganic material such as natural or synthetic minerals. Examples of useful materials are kaolinites, smectites, talcites, calcium carbonate minerals, precipitated silica, gel-type silica, fumed silica, precipitated calcium carbonate, and mixtures thereof.

It is preferred that the porous aggregates and the extender particles have opposite net charges. Thus, if the porous aggregates are have a positive net charge it is preferred to use extender particles with a negative net charge, and vice versa.

It is preferred that at least some of the porous aggregates, for example from about 1 to about 100 wt %, preferably from about 5 to about 100 wt %, most preferably from about 30 to about 100 wt % are attached to extender particles. The mean particle size of the entire pigment composition is preferably from about 0.5 μm to about 50 μm, most preferably from about 1 μm to about 25 μm. The specific surface of the entire composition is preferably from about 35 m²/g to about 1000 m²/g, most preferably from about 50 m²/g to about 700 m²/g. In an embodiment the specific surface is up to about 600 m²/g, preferably up to about 450 m²/g, most preferably up to about 400 m²/g. The total content of porous aggregates and extender particles in the composition is preferably from about 1 wt % to about 60 wt %, most preferably from about 5 wt % to about 50 wt %, particularly most preferably from about 10 wt % to about 50 wt %. The composition may further comprise other additives, such as stabilisers or remaining impurities from the raw materials or substances from the aggregation like salts and bridging agents.

Regardless of the method of aggregation, the composition may comprise at least one water soluble aluminium salt, preferably in an amount from about 0.1 wt % to about 30 wt % most preferably from about 0.2 wt % to about 15 wt %, calculated as wt % Al₂O₃ on dry porous aggregates and extender particles. Examples of salts include aluminium chloride, poly aluminium chloride, poly aluminium silicate sulfate, aluminium sulfate, zirconium carbonates, zirconium acetates, and mixtures thereof. The aluminium may be present partly or fully on the surface of the particles of silica or aluminosilicate or in the aqueous phase. The entire content of water soluble aluminium salt may originate from what is present in a cationic aluminium modified silica sol used for preparing the pigment composition. However, the pigment composition may also comprise additional aluminium salt.

Regardless of the method of aggregation, the composition may comprise at least one cationic polymer, preferably having a molecular weight from about 2000 to about 1000000, more preferably from about 2000 to about 500000, most preferably from about 5000 to about 200000. The charge density of the polymer is preferably from about 0.2 meq/g to about 12 meq/g, more preferably from about 0.3 meq/g to about 10 meq/g, most preferably from about 0.5 meq/g to about 8 meq/g. The cationic polymer is preferably present in the composition in an amount from about 0.1 wt % to about 30 wt %, more preferably from about 0.5 wt % to about 20 wt %, most preferably from about 1 wt % to about 15 wt %, based on the amount of dry porous aggregates and extender particles. Examples of suitable cationic polymers include synthetic and natural polyelectrolytes such as PAM (polyacrylamides), polyDADMAC (poly diallyl dimethyl ammoniumchloride), polyallyl amines, polyamines, polysaccharides and mixtures thereof, provided they are cationic and preferably that the molecular weight and charged density fulfil the above requirements. The cationic polymer may be present partly or fully on the surface of the particles of silica or aluminosilicate or in the aqueous phase.

A pigment composition as described above is preferably storage stable for at least one week, most preferably at least one month. The composition may be used directly for coating paper or paperboard or form an intermediate product for preparing a coating composition.

A further aspect of the invention concerns a process for the production of a pigment composition as described above. One alternative process comprises a step of mixing:
a) an aqueous dispersion of porous aggregates formed by aggregation of colloidal primary particles of silica, aluminosilicate or a mixture thereof in an aqueous sol, said porous aggregates having a mean diameter from about 0.03 μm to about 25 μm, and,
b) extender particles where the mean size of at least one dimension is larger than the mean diameter of the porous aggregates,
   wherein the weight ratio of porous aggregates to extender particles is from about 0.01:1 to about 3:1, preferably from about 0.03;1 to about 2:1, most preferably from about 0.05:1 to about 1.5:1.

Another alternative process comprises the steps of:
a) mixing an aqueous sol comprising colloidal primary particles of silica or aluminosilicate and extender particles in a weight ratio primary particles of silica or aluminosilicate to extender particles from about 0.01:1 to about 3:1, preferably from about 0.03;1 to about 2:1, most preferably from about 0.05:1 to about 1.5:1; and,
b) aggregating the colloidal primary particles of silica or aluminosilicate to form porous aggregates having a mean diameter from about 0.03 μm to about 25 μm, but not exceeding the mean size of the largest dimension of the extender particles.

In either alternative process the extender particles may be added as a solid powder, in the form of an aqueous dispersion or in any other suitable form. Regarding the formation of the porous aggregates, addition of any optional additives and other various embodiments, the above description of the pigment composition is referred to.

Still a further aspect of the invention concerns a coating composition suitable for coating paper or paper board comprising a binder and a pigment composition as described above. Examples of possible binders are polyvinyl alcohols, optionally modified starches, gums, protein binders (e.g. caseins and soy protein binders), latices and mixtures thereof. Latices can be based on styrene butadien, acrylates, vinyl acetate, co-polymers of ethylene and vinyl acetates, styrene acrylic esters etc. Polyvinyl alcohols are particularly preferred. The coating composition may also comprise other additives commonly used such as rheology modifiers, optical brighteners, lubricants, insolubilizers, dyes, sizing agents etc. The dry content of the coating composition is preferably from about 2 wt % to about 75 wt %, most preferably from about 10 wt % to about 70 wt %. The amount of porous aggregates and extender particles from the pigment composition is preferably from about 30 to about 99 wt %, most preferably from about 50 to about 90 wt %, based on the dry content. The amount of binder is preferably from about 1 to about 70 wt %, most preferably from about 10 to about 50 wt %, based on the dry content. The total amount of other additives and possible impurities is preferably from 0 to about 50 wt %, most preferably from 0 to about 30 wt %, based on the dry content. Regarding suitable and preferred embodiments the above description of the pigment composition is referred to.

Still a further aspect of the invention concerns a process for the production of a coating composition comprising a step of mixing binder with a pigment composition as described above. The binder and any optional additive may be added to the pigment composition in any suitable form, for example as solid material, liquid material, or as an aqueous solution, dispersion or slurry. Regarding suitable and preferred embodiments the above description of the coating composition and the pigment composition is referred to.

Another aspect of the invention concerns a process for the production of coated paper or paperboard comprising a step of applying a coating composition as described above to at least one side of a paper or paperboard web.

The coating is preferably applied in an amount sufficient to yield at least from about 0.4 g/m², preferably from about 0.5 g/m² to about 40 g/m², most preferably from about 1 g/m² to about 20 g/m² of porous aggregates and extender particles from the pigment composition per coated side of the paper or paper board. In most cases the dry amount of coating applied per coated side of the paper or paper board is preferably at least from about 0.6 g/m², preferably from about 0.7 g/m² to about 50 g/m², most preferably from about 1.5 g/m² to about 25 g/m².

The coating is preferably applied to a non-coated side of the paper or paper board but may also be applied on top of a previously applied coating layer with the same or another coating composition. It is preferred not to apply any further coating of other kind on top of the layer formed from the coating as described herein.

Applying the coating can be performed either on the paper or board machine or off the paper or board machine. In either case any type of coating methods can be used. Examples of coating methods are blade coating, air knife coating, roll coating, curtain coating, spray coating, size press coating (e.g. film press coating) and cast coating.

After applying the coating the paper is dried, which in the case of on machine coating preferably is accomplished in a drying section of the machine. Any means of drying may be used, such as infra red radiation, hot air, heated cylinders or any combination thereof.

The term coating as used herein refers to any method in which pigments are applied to the surface of paper or paper board, thus including not only conventional coating but also other methods such as for example pigmenting.

The paper and paper board to be coated can be made from any kind of pulp, such as chemical pulp like sulfate, sulfite and organosolve pulps, mechanical pulp like thermo-mechanical pulp (TMP), chemo-thermo-mechanical pulp (CTMP), refiner pulp or ground wood pulp, from both hardwood and softwood bleached or unbleached pulp that is based on based on virgin or recycled fibres or any combination thereof. Paper and paper board from any other kind of pulp may also be coated in accordance with the invention.

Regarding further details and embodiments of the coating composition, the above description of the same is referred to.

The invention finally concerns paper or paper board suitable for ink-jet printing obtainable by a process as described above. Such paper or paper board comprises a preferably substantially non-transparent layer comprising porous aggregates and extender particles from the coating composition preferably forming a nano-structure. The dry amount of coating is preferably at least from about 0.6 g/m², preferably from about 0.7 g/m² to about 50 g/m², most preferably from about 1.5 g/m² to about 25 g/m². The amount of porous aggregates and extender particles from the pigment composition per coated side of the paper or paper board is preferably at least from about 0.4 g/m², preferably from about 0.5 g/m² to about 40 g/m², most preferably from about 1 g/m² to about 20 g/m². Preferably no other kind of coating has been applied on top of this layer.

It has been found that the paper or paper board of the invention have good properties for ink-jet printing, giving low line blurriness and mottling and high printing density for colours, but can advantageously also be used for other kinds of printing processes like toner, flexography, letter press, gravure, offset lithography and screen printing. It is a particular advantage that such good properties can be obtained in a simple manner by applying only small amounts of the coating and without the need to apply numerous different coating layers on the paper or paper board. This also enable the coating to be applied with a size press, such as a film press, which for practical reasons is advantageous. Furthermore, the main components of the pigment composition can be made from readily available raw materials.

The invention will now be further described in following examples. Unless otherwise stated all parts and percentages refer to parts and percent by weight.

### EXAMPLE 1

### Four Pigment Compositions were Prepared

A: A cationic aqueous silica sol, Bindzil® CAT 220 from Eka Chemicals AB containing 30 wt % SiO₂ with a mean primary particle diameter of about 15 nm was diluted to 10 wt %. The diluted silica sol was stirred in glass beaker and 0.06 moles/l aluminium sulfate solution was added drop wise until the sol turned white and the viscosity increased, which occurred when the concentration of aluminium sulfate reached 0.0125 moles/I in the solution. The mean diameter of aggregates was determined to 0.3 μm (measured on a Zetamaster from Malvern instrument, monomodal analysis).

B: A 20 wt % aqueous dispersion of extender particles was prepared from a coating clay (SPS, Imerys, UK). The mean particle size of the clay was determined to 1.64 μm by using a Mastersizer Micro Plus from Malvern Instrument (method 50HD).

C: 30 ml of the clay dispersion prepared in B was mixed with 15 ml of the same diluted silica sol as in A, but without prior aggregation.

D: 15 ml of the aggregated silica sol prepared in A was mixed with the 30 ml clay dispersion prepared in B giving a pigment composition comprising aggregates of silica and extender particles.

Each of the above pigment compositions were used for preparing coating formulations by mixing with a laboratory grade polyvinyl alcohol (MW 150000) dissolved in water as a 10 wt % solution. All formulation had a solid content of about 15 wt % and a weight ratio polyvinyl alcohol to solid pigments of 0.5:1.

The coating formulations were applied on the surface of uncoated copy paper (A4 sized Data Copy from M-real) by a drawdown method with a wired rod, whereupon the papers were dried over a drying drum. A test picture containing blocs of cyan, magenta, yellow and black was printed on each of the dried papers with an ink jet printer from Hewlett-Packard (HP Deskjet 970Cxi). For each colour the colour density was determined with a colour densitometer (GretagMacbeth D19C, Gretag AG) and figures are shown in the table below:

| Pigment | Coat wt. | | | | |
|---|---|---|---|---|---|
| composition | (g/m²) | Cyan | Magenta | Yellow | Black |
| Blank | 0 | 1.08 | 1.18 | 1.01 | 2.40 |
| A | 3.0 | 1.23 | 1.38 | 1.04 | 2.98 |
| B | 2.8 | 1.31 | 1.56 | 1.12 | 2.10 |
| C | 3.5 | 0.95 | 1.10 | 0.80 | 2.70 |
| D | 2.5 | 1.41 | 1.66 | 1.16 | 2.80 |

From this experiment it can be seen that coating formulation including the pigment composition D gave the best over-all print density. It was also noted that the printed colours on paper coated with pigment composition A was strongly mottled.

### EXAMPLE 2

### Four Pigment Compositions were Prepared

A: Two aqueous silica sols were used, an anionic silica sol, Bindzil® 15/500, and a cationic silica sol, Bindzil® CAT, both from Eka Chemicals and containing 15 wt % SiO₂ and having a mean primary particle diameter of about 6 nm. 37.5 g of a 30 wt % aqueous clay dispersion (same clay as in Example 1, mean particle size 1,64 μm), 90 g of the cationic sol, 135 g of the anionic sol, and 37.5 g water were mixed under vigorous stirring which gave a high viscous pigment composition comprising aggregates of primary silica particles from the sols and extender particles from the clay. The mean diameter of aggregated silica sol before extender addition was determined to 0.57 μm (momomodal analysis on the Zetamaster).

B: 102 g of precipitated silica, Tixosil™ 365 SP from Rhodia with a solid content of 22 wt % and mean particle size of 3.4 μm (Mastersizer) was mixed with 60 g of cationic silica sol 90 g of anionic silica sol and 48 g water in the same way as in A giving a high viscous pigment composition comprising aggregates of primary silica particles from the sols and extender particles from the precipitated silica. The mean diameter of aggregated silica sol before extender addition was determined to 0.69 μm (measured on the Zetamaster).

C: Same clay dispersion as used in A

D: Same precipitated silica as used in B.

Each of the above pigment compositions were used for preparing coating formulations by mixing with a polyvinyl alcohol binder (ERKOLT™ 26/88 from ACETEX Co., Spain). All formulation had a solid content of about 15 wt % and a weight ratio polyvinyl alcohol to solid pigments of 0.25:1.

The coating was applied on copy paper as in Example 1. A test picture containing blocs of cyan, magenta, yellow, green, blue, red and black was printed on each of the coated papers with an Epson Stylus C84 ink-jet printer using a pigmented ink for all colours. The printed blocs and the unprinted paper were measured with a spectrophotometer (Color Touch 2 from Technidyne) and the colour gamut volume was calculated. The gamut volume is approximated with a dodecahedral in the CEI L*a*b* colour space and the measurements of the colours give the corners in the dodecahedral (see “Rydefalk Staffan, Wedin Michael; Litterature review on the colour Gamut in the Printing Process-Fundamentals, PTF-report no 32, May 1997”).

The results are shown in the table below:

| Pigment | Coat Weight | |
|---|---|---|
| composition | (g/m²) | Gamut Volume |
| Blank | 0 | 148600 |
| A | 3.7 | 214000 |
| B | 3.6 | 221900 |
| C | 3.3 | 187300 |
| D | 3.3 | 188900 |

From these results it could be seen that the pigment compositions A and B gave a higher print quality as measured as gamut volume.

### EXAMPLE 3

### Two Pigment Compositions were Prepared

A: 16,7 g of a 30 wt % aqueous dispersion of coating clay (same as in Example 1, particle size 1.64 μm), 10 g of Bindzil 50/80 (50 wt % silica sol with mean particle size of 40 nm, from Eka Chemicals), 3 g Eka ATC 8210 (25 wt % poly aluminium chloride from Eka Chemicals) and 70 g water were mixed under vigorous stirring in an UltraTurrax (10 000 rpm). This gave a 10 wt % pigment dispersion with a weight ratio of silica to clay of 1:1. The mean diameter of aggregated silica sol before extender addition was determined to 0.45 μm (momomodal analyse on the Zetamaster).

B: 16,7 g of a 30 wt % aqueous dispersion of coating clay (same as in Example 1), 5 g of a silica gel type of product (dry powder) and 78 g water were mixed (UltraTurrax as in A) to obtain a 10 wt-% pigment dispersion (silica/clay ratio:1:1). This silica gel type product (Grace Davison) had a secondary particle size of 12 μm and a surface area of 400 g/m², corresponding to a primary particle size of 7 to 8 nm.

Coating formulations having a solid content of 10 wt % and weight ratio polyvinyl alcohol to solid pigment of 0.25:1 were prepared as in Example 2. The coatings were applied to paper and dried on an IR-drier (Hedson Technologies AB, Sweden) Print tests were performed with Epson Stylus C84 and HP5652 (Hewlett Packard) ink-jet printers as described in Example 2. The results appear in table below:

| Pigment | Coat Weight | Gamut Volume | Gamut Volume |
|---|---|---|---|
| composition | (g/m²) | Epson | HP |
| Blank | 0 | 185700 | — |
| Blank | 0 | — | 162100 |
| A | 2.5 | 220500 | — |
| A | 2.7 | — | 232900 |
| B | 2.3 | 200000 | — |
| B | 2.3 | — | 193700 |

The pigment composition containing silica sol aggregates (A) gave higher gamut volumes than corresponding pigment composition containing gel type of silica. A careful visual inspection revealed a good line sharpness and no colour bleeding for the printouts.

### EXAMPLE 4

### Two Pigment Compositions were Prepared

A: An anionic silica sol prepared by ion exchange method containing 10 wt % SiO₂ and having a surface area of about 865 m²/g was aggregated by slowly adding 14.2 g of a 2.5 wt % aqueous solution of modified carboxy methyl cellulose (CMC) to 100 g silica sol under continuous stirring to give a high viscous clear solution. The modified CMC had a DS of 0.65 with respect to carboxyl groups and was further modified by incorporation of quaternary nitrogen groups (DS 0.43) giving a cationic character of the product. The mean particle diameter of the aggregates in the dispersion was determined to 0.7 μm by using the Zetamaster. The dispersion was then vigorously mixed with 45 g of the precipitated silica (Tixosil 365 SP, mean particle size 3.4 μm, see example 2) and 45 g water.

B: A 10 wt % aqueous dispersion of the precipitated silica (Tixosil 365 SP) was prepared.

Coating formulations having a solid content of about 10 wt % and a weight ratio polyvinyl alcohol to solid pigment of 0.25:1 were prepared as in Example 2. The coatings were applied to paper and dried as in Example 3. Print tests were performed as in Example 2 with two inkjet printers, Epson C84 and HP 5652. The gamut volume was measured and the following results were obtained.

| Pigment | Coat Weight | Gamut Volume | Gamut Volume |
|---|---|---|---|
| composition | (g/m²) | Epson | HP |
| A | 2.7 | 225000 | — |
| A | 2.7 | — | 230700 |
| B | 2.5 | 209700 | — |
| B | 2.4 | — | 222400 |

It appears the pigment composition A gives better print quality than composition B.

1. Pigment composition in the form of an aqueous dispersion comprising:
(a) porous aggregates formed by aggregation of colloidal primary particles of silica, aluminosilicate or a mixture thereof in an aqueous sol, said porous aggregates having a mean diameter from about 0.03 to about 25 μm, and,
(b) extender particles where the mean size of at least one dimension is larger than the mean diameter of the porous aggregates,
wherein the weight ratio of porous aggregates to extender particles is from about 0.01:1 to about 3:1.

2. Composition as claimed in claim 1, wherein the colloidal primary particles of silica or aluminosilicate have been formed from an aqueous solution of alkali metal silicate where alkali metal ions are removed through an ion exchange process or where the alkali metal silicate has been neutralised by the addition of an acid.

3. Composition as claimed in claim 1, wherein at least some of the porous aggregates are attached to extender particles.

4. Composition as claimed in claim 1, wherein the porous aggregates and the extender particles have opposite net charges.

5. Composition as claimed in claim 1, wherein the extender particles are of a material selected from the group consisting of kaolinites, smectites, talcites, calcium carbonate minerals, precipitated silica, gel-type silica, fumed silica, precipitated calcium carbonate, and mixtures thereof.

6. Composition as claimed in claim 1, wherein total content of porous aggregates and extender particles in the composition is from about 1 to about 60 wt %.

7. A process for the production of a pigment composition comprising a step of mixing:
(a) an aqueous dispersion of porous aggregates formed by aggregation of colloidal primary particles of silica, aluminosilicate or a mixture thereof in an aqueous sol, said porous aggregates having a mean diameter from about 0.03 to about 25 μm, and,
(b) extender particles where the mean size of at least one dimension is larger than the mean diameter of the porous aggregates,
wherein the weight ratio of porous aggregates to extender particles is from about 0.01:1 to about 3:1.

8. A process for the production of a pigment composition comprising the steps:
(a) mixing an aqueous sol comprising colloidal primary particles of silica or aluminosilicate and extender particles in a weight ratio primary particles of silica or aluminosilicate to extender particles from about 0.01:1 to about 3:1; and,
(b) aggregating the colloidal primary particles of silica or aluminosilicate to form porous aggregates having a mean diameter from about 0.03 um to about 25 um, but not exceeding the mean size of the largest dimension of the extender particles.

9. Coating composition suitable for coating paper or paper board comprising a binder and a pigment composition comprising:
(a) porous aggregates formed by aggregation of colloidal primary particles of silica, aluminosilicate or a mixture thereof in an aqueous sol, said porous aggregates having a mean diameter from about 0.03 to about 25 μm, and,
(b) extender particles where the mean size of at least one dimension is larger than the mean diameter of the porous aggregates,
wherein the weight ratio of porous aggregates to extender particles is from about 0.01:1 to about 3:1.

10. Coating composition as claimed in claim 9, wherein the binder is selected from the group consisting of polyvinyl alcohols, optionally modified starches, gums, protein binders, latices and mixtures thereof.

11. A process for the production of a coating composition comprising a step of mixing a binder with a pigment composition comprising:
(a) porous aggregates formed by aggregation of colloidal primary particles of silica, aluminosilicate or a mixture thereof in an aqueous sol, said porous aggregates having a mean diameter from about 0.03 to about 25 μm, and,
(b) extender particles where the mean size of at least one dimension is larger than the mean diameter of the porous aggregates,
wherein the weight ratio of porous aggregates to extender particles is from about 0.01:1 to about 3:1.

12. A process for the production of coated paper or paperboard comprising a step of applying a coating composition to at least one side of a paper or paperboard web, said coating composition comprising:
(a) porous aggregates formed by aggregation of colloidal primary particles of silica, aluminosilicate or a mixture thereof in an aqueous sol, said porous aggregates having a mean diameter from about 0.03 to about 25 μm, and,
(b) extender particles where the mean size of at least one dimension is larger than the mean diameter of the porous aggregates,
wherein the weight ratio of porous aggregates to extender particles is from about 0.01:1 to about 3:1.

13. A process as claimed in claim 12, wherein the coating is applied in an amount sufficient to yield from about 0.4 g/m² to about 40 g/m², of porous aggregates and extender particles from the pigment composition per coated side of the paper or paper board.

14. Coated paper or paper board produced by a process comprising a step of applying a coating composition to at least one side of a paper or paperboard web, said coating composition comprising:
(a) porous aggregates formed by aggregation of colloidal primary particles of silica, aluminosilicate or a mixture thereof in an aqueous sol, said porous aggregates having a mean diameter from about 0.03 to about 25 μm, and,
(b) extender particles where the mean size of at least one dimension is larger than the mean diameter of the porous aggregates,
wherein the weight ratio of porous aggregates to extender particles is from about 0.01:1 to about 3:1.
